(19) United States
(12) Patent Application Publication
(10) Pub. No.: US 2026/0065812 A1
(43) Pub. Date: Mar. 5, 2026

(54) BLESSING AND GOOD FORTUNE COUNTER AND DISPLAY

(71) Applicant: Benjamin Elias Blumenthal, Dallas, TX (US)

(72) Inventor: Benjamin Elias Blumenthal, Dallas, TX (US)

(21) Appl. No.: 18/819,689

(22) Filed: Aug. 29, 2024

(51) Int. Cl. G09F 7/04; G09F 7/00; G09F 7/08; G09F 7/12; G09F 9/30

(52) U.S. Cl. CPC G09F 7/04; G09F 7/08; G09F 7/12; G09F 9/30; G09F 2007/005; G09F 2007/127

(57) ABSTRACT

The invention discloses devices for providing continuous reminder of blessings or good fortune in order to reduce depression and suicide and increase personal gratitude, happiness and overall quality of life. Reminder labels are generally placed in a categorized space defined by a back unit and held in place by magnets. Dials and sliding bars may be provided to offer a different configuration and sensors, a controller and display may be included to calculate and display an overall fortune or blessing score.

### FIELD AND BACKGROUND OF THE INVENTION

The present invention, in some embodiments thereof, relates to devices for providing continuous reminder of blessings or good fortune to reduce depression and suicide and increase gratitude, happiness and overall quality of life. The instant invention, in some embodiments, allows for a plurality of labels to be placed, updated, and changed on a display board for private or public viewing.

One of the most common sources of unhappiness and suffering in today's society is the inability to remember the blessings or good fortune that one currently has in their life. Too often, teenagers resort to depression, and in extreme cases suicide, because they lack the perspective to be grateful for what they do have, and instead focus on what they do not have. The young boy who is depressed over the girl's rejection has lost perspective that he has caring parents, plenty of food, clean water to drink, clean air to breathe, both legs that work, a healthy body, a community of friends and much more.

In many cases, a teenager or similarly affected adult is reminded of some of these blessings, or areas of their good fortune, by friends, family or clergy. Unfortunately, that is not always the case. Regaining positive perspective is critical to regaining mental health.

The current invention is a Blessing Counter, a device intended to hang on a wall or be made available for public or private display, with the specific intended purpose of reminding an individual or community of the blessings they have in their lives and to assist in regaining and maintaining a proper, positive perspective on their lives, with the ultimate aim of increasing gratitude and happiness.

U.S. Patent Application Number US20070194187A1 to Amron teaches an invention related to a refrigerator magnet with clipping action in which a magnetic device is provided for holding paper memos, documents, notices, notes, photos and similar non-magnetic thin sheet materials against a flat or rounded, usually vertically oriented, magnetically attractive surface such as a refrigerator door.

U.S. Pat. No. 3,214,171A to Luchland describes an invention related to a magnetic game comprising a playing board having spaced apart parallelly disposed top and bottom walls; and circumferentially extending opposed side and end walls interconnected between said top and bottom walls to define an enclosure forming a playing area and other related game features.

U.S. Patent Application Number US Application US20060088807A1 to Lee describes a prayer/blessing kit which is comprised of a briefcase that contains salt, a receptacle and a prayer sheet being disposed in the receptacle. The prayer/blessing kit allows individuals who are not officials of a religious institution to administer a blessing.

China Patent Application CN102062307A to [symbol] describes a brightness blessing lamp structure that mainly comprises an accommodating space with an opening, wherein the accommodating space is formed in a lamp holder; a sheet backlight assembly serving as a light source body is arranged in the accommodating space so as to generate uniformly scattered light rays.

### SUMMARY OF THE INVENTION

It is therefore a purpose of the present invention, in some embodiments, to describe methods and devices for providing continuous reminder of blessings or good fortune to reduce depression and suicide, and increase gratitude, happiness and overall quality of life.

The invention includes a display system, including the following: a display board; a plurality of labels adapted to be attached to predetermined positions on the display board; a plurality of magnets adapted to be placed under the labels, wherein a magnetic bond is made to enable the labels to remain firmly situated on the display board; a pouch to hold unattached and blank labels; and, a changeable graphic display attached to the display board.

In one aspect of the system, the labels are pre-printed with categories of good fortune. Said categories could include as example: Health, Family, Children, Friends, Community, Education, Freedom, Employment, Good Income, Opportunity, Faith, Tradition, Ability to give to others, Time to spend with loved ones.

In another aspect of the system, at least two categories are offered into which the labels are placed on the display board. Said categories could include as example: Still Praying For, Blessed, and Super-Blessed.

In another aspect of the system, the labels are not pre-printed but are blank, enabling the user to write in their own blessing or good fortune.

In another aspect of the system, the labels are attached to the predetermined positions using a magnetic system.

In another aspect of the system, the labels are attached to the predetermined positions using a semi-adhesive sticker system.

In another aspect of the system, a calendar is associated with the display board to encourage daily viewing.

In another aspect of the system, the labels are replaced with dials that indicate a low, medium or high degree of blessing.

In another aspect of the system, the labels are replaced with vertical sliding bars that indicate a low, medium or high degree of blessing.

In another aspect of the system, the display board may include an electronic sensor that calculates the position of the labels, dials or sliding bars, and calculates a Blessing Score, which is shown on a digital read-out on the display board.

The invention also includes a blessing counting device, including the following: a display board; a plurality of labels adapted to be attached to predetermined positions on the display board; a plurality of magnets adapted to be placed under the labels, wherein a magnetic bond is made to enable the labels to remain firmly situated on the display board; a pouch to hold unattached and blank labels; and, a changeable graphic display attached to the display board.

In one aspect of the device, the labels are pre-printed with categories of good fortune. Said categories could include as example: Health, Family, Children, Friends, Community, Education, Freedom, Employment, Good Income, Opportunity, Faith, Tradition, Ability to give to others, Time to spend with loved ones.

In another aspect of the device, at least two categories are offered into which the labels are placed on the display board. Said categories could include as example: Still Praying For, Blessed, and Super-Blessed.

In another aspect of the device, the labels are not pre-printed but are blank, enabling the user to write in their own blessing or good fortune.

In another aspect of the device, the labels are attached to the predetermined positions using a magnetic system.

In another aspect of the device, the labels are attached to the predetermined positions using a semi-adhesive sticker system.

In another aspect of the device, a calendar is associated with the display board to encourage daily viewing.

In another aspect of the device, the labels are replaced with dials that indicate a category of blessing.

In another aspect of the device, the labels are replaced with vertical sliding bars that indicate a category of blessing.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. It is noted that similar elements in various drawings may have the same number, advanced by the appropriate multiple of 100.

In the drawings:

FIG. 1 shows the front view of the device;

FIG. 2 shows a model of a label, both pre-printed and blank;

FIG. 3 shows a model of a label with a magnetic strip included;

FIG. 4 shows a model of a label with an adhesive sticker included;

FIG. 5 shows a model of the device with a daily attention item included;

FIG. 6 shows an embodiment of the device with dials included;

FIG. 7 shows an embodiment of the device with slidable indicators included;

FIG. 8 shows an embodiment of the device with sensors, a controller, a digital display and a battery included;

### DESCRIPTION OF SPECIFIC EMBODIMENTS OF THE INVENTION

The present invention, in some embodiments thereof, relates to devices and systems for providing continuous reminder of blessings or good fortune to reduce depression and suicide and increase gratitude, happiness and overall quality of life. In some embodiments, the display board may be adapted to allow a user to post reminder labels onto the display board using a magnetic seal. In other embodiments, the labels may be periodically changed or reorganized.

For purposes of better understanding, some embodiments of the present invention are illustrated in the figures of the drawings. Without being bound by any theory, the following discussion is offered.

### First Embodiment

The invention includes a display system, including the following: a display board; a plurality of labels adapted to be attached to predetermined positions on the display board; a plurality of magnets adapted to be placed under the labels, wherein a magnetic bond is made to enable the labels to remain firmly situated on the display board; a pouch to hold unattached and blank labels; and, a changeable graphic display attached to the display board.

In one aspect of the device, the labels are pre-printed with categories of good fortune. Said categories could include as example: Health, Family, Children, Friends, Community, Education, Freedom, Employment, Good Income, Opportunity, Faith, Tradition, Ability to give to others, Time to spend with loved ones. In another aspect of the device, at least two categories are offered into which the labels are placed on the display board. Said categories could include as example: Still Praying For, Blessed, and Super-Blessed.

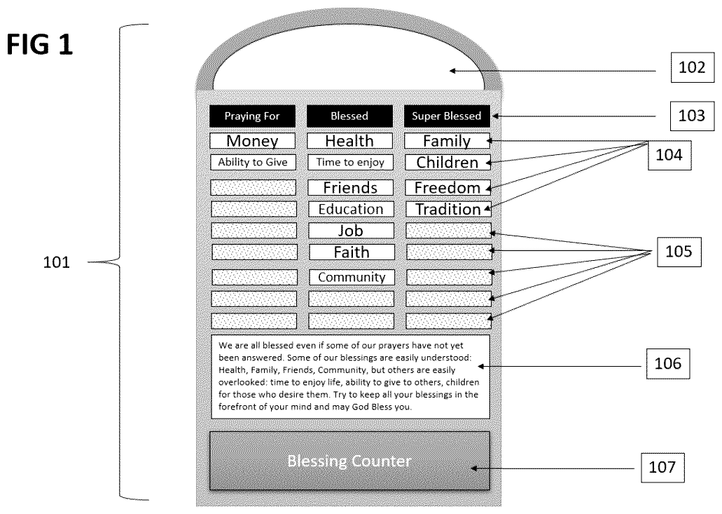

Attention is turned to FIG. 1 which shows a frontal view of the instant embodiment. A display board 101 includes a graphic display 102 and blessing categories 103. Labels 104 are placed into predetermined slots 105 under the correct blessing category 103. The labels are held in place by magnets (not shown in this figure). User instructions are provided in an instructional space 106. Labels not being used are stored in a label pouch 107.

In another aspect of the device, the labels are not pre-printed but are blank, enabling the user to write in their own blessing or good fortune.

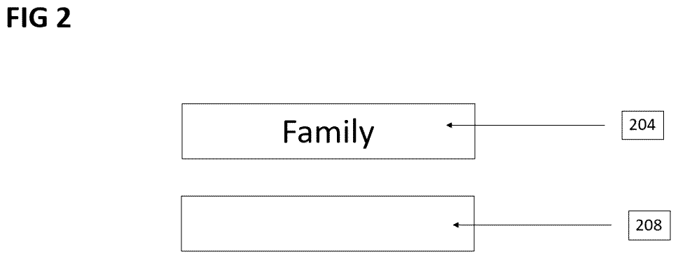

Attention is turned to FIG. 2 which shows a frontal view of a pre-printed label 204 and a frontal view of a blank label 208.

In another aspect of the device, the labels are attached to the predetermined positions using a magnetic system.

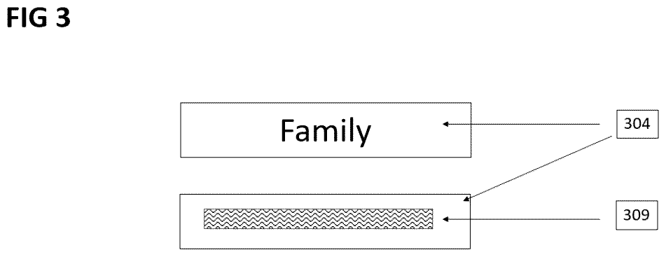

Attention is turned to FIG. 3 which shows a frontal view of label 304 and a rear view of label 304 with magnet 309 that attaches to display board 101 (FIG. 1).

In another aspect of the device, the labels are attached to the predetermined positions using an adhesive sticker system.

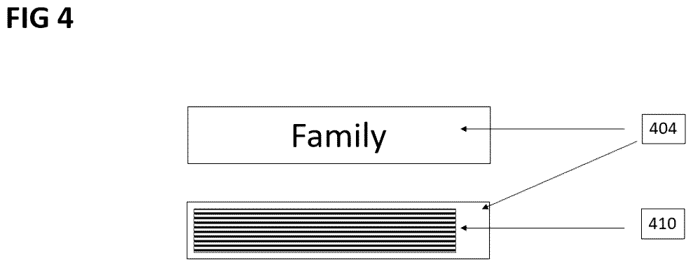

FIG. 4 which shows a frontal view of label 404 and a rear view of label 304 with adhesive sticker 410 that attaches to display board 101 (FIG. 1).

In another aspect of the device, an item that requires daily interaction such as a calendar, daily vocabulary word list, shopping list, day planner, daily words of wisdom or the like is associated with the display board to encourage daily viewing.

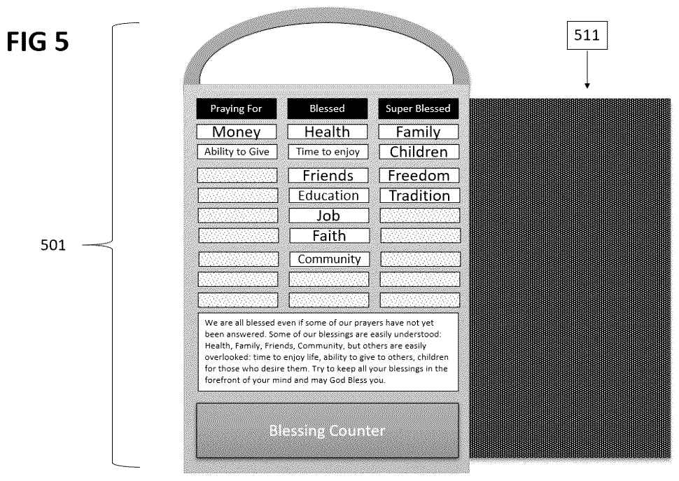

FIG. 5 shows a frontal view of display board 501 with the associated daily interaction item 511.

In another aspect of the device, the labels are replaced with dials that can be turned to indicate a category.

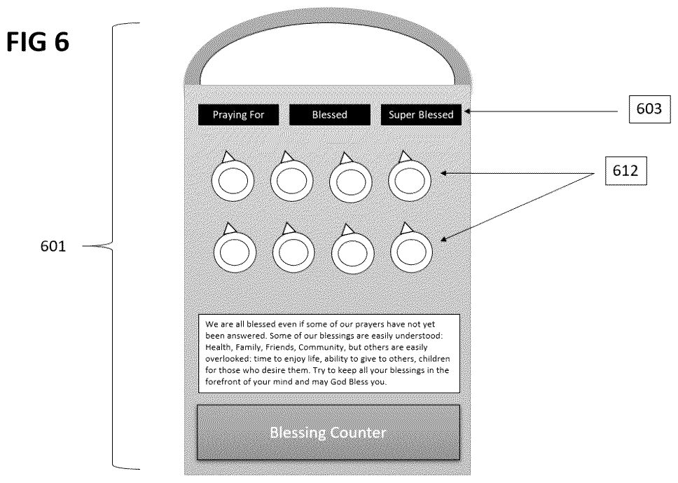

FIG. 6 shows a frontal view of display board 601 with dials 612 that can be repositioned by turning to point to category 603.

In another aspect of the device, the labels are replaced with vertical sliding bars that indicate a category of blessing or good fortune.

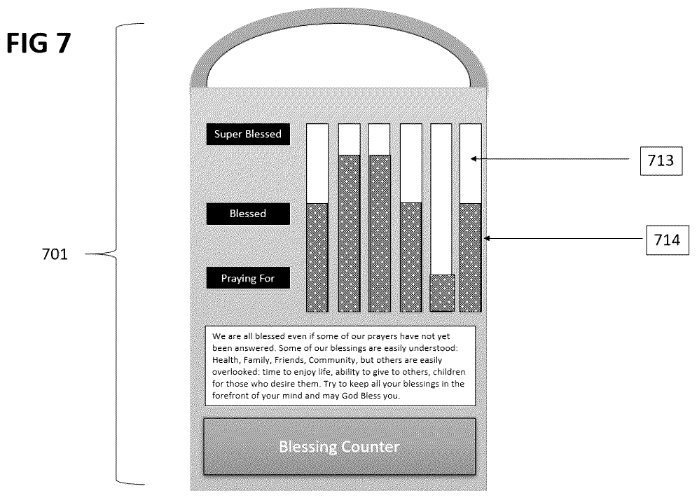

FIG. 7 shows a frontal view of display board 701 with predetermined spaces 713 that are filled with slidable indicators 714 to line up with categories 703.

### Second Embodiment

The invention also includes a display system, including the following: a display board; a plurality of labels, dials or sliding bars adapted to be attached to predetermined positions on the display board; a plurality of sensors adapted to be placed under the labels, wherein the electronic sensors calculates the position of the labels, dials or sliding bars, and calculates a Blessing Score, which is shown on a digital read-out on the display board.

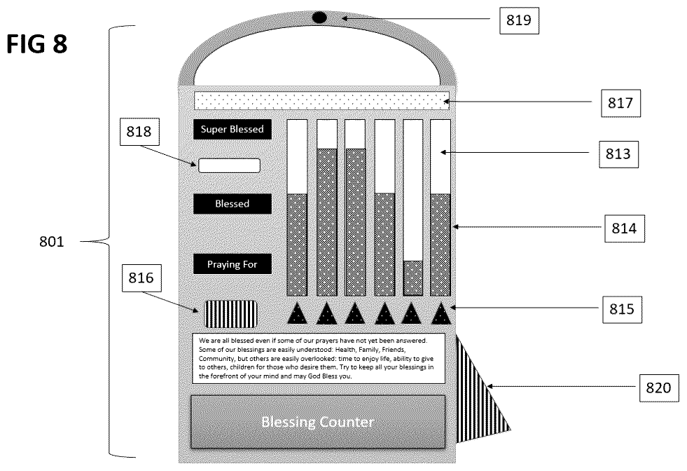

FIG. 8 shows a frontal view of display board 801 with predetermined spaces 813 that are filled with slidable indicators 814 whose level is monitored by sensors 815. Sensors 815 relays said position of slidable indicator levels 814 to controller 816 that calculates and displays overall good fortune score on digital display 817. The electrical systems are powered by battery 818. The device may be attached to a wall via hole 819 or a stand 820 may be applied to the back side of the display board 801 to enable it to rest on a table (not shown) in a manner similar to a picture frame (not shown).

### Example

After a particularly bad fight with his boss and business colleagues, a man comes home and sits at his dinner table in a bad mood, convinced that his life is terrible. He looks at the Blessing Counter hanging on his dining room wall and notices that has a significant amount of good fortune and blessings in his life. He is reminded that he has a loving wife, two happy children, his health and the health of his family, close friends that he can turn to, and a community at his local church that are also there to support him. He is reminded that he lives in a country where he is free and that soldiers have died protecting that freedom. He remembers that he has a good education and that his children enjoy the same opportunity to get a world-class education. Although his day was tough, he remembers that it is good he still has a job that provides financially for his family. He remembers that he can and should give to others, especially on bad days. He remembers that for years he struggled with many things in his life, and he is in a much better place now. He takes a moment to count those blessings and returns his attention to his dinner table with a new perspective on his day and current situation. With the Blessing Counter as a reminder, he was able to take a few simple moments of reflection, change his perspective, and increase his own quality of his life and that of his entire family.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range. In addition, as used herein the term “about” refers to +/−10 %. In addition, when the word “about” is used herein in reference to a number, it should be understood that still another embodiment of the invention includes that number not modified by the presence of the word “about.”

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A good fortune counting and display system, including the following:
a display board;
a plurality of labels adapted to be attached to predetermined positions on the display board;
a plurality of magnets adapted to be placed under the labels;
a pouch to hold unattached and blank labels;
a changeable graphic display attached to the display board;
a hole to receive a fastener to secure to wall;
a stand to enable desktop display (as seen with picture frames).

2. The system according to claim 1, further including both pre-printed labels and blank labels for users to customize.

3. The system according to claim 1, further including predetermined slots into which the labels are placed.

4. The system according to claim 1, further including categorical specifications that allow the labels to be categorized by their placement.

5. The system according to claim 1, including a plurality of magnets that enable the plurality of labels to remain in a fixed position.

6. The system according to claim 1, including the plurality of adhesive sticker backing that enable the plurality of labels to remain in a fixed position.

7. The system according to claim 1, wherein a plurality of dials are used in lieu of a plurality of labels to indicate categorization.

8. The system according to claim 1, wherein a plurality of sliding mechanisms are used in lieu of a plurality of labels to indicate categorization.

9. The system according to claim 1, wherein a pouch is attached to the display board that can contain user instructions, blank labels and pre-printed labels not being used.

10. The system according to claim 1, further including a lighting element to enable at least part of the display board to be seen in dim or dark environments.

11. A good fortune counting and display system, including the following:
a display board;
a plurality of labels adapted to be attached to predetermined positions on the display board;
a plurality of magnets adapted to be placed under the labels;
a pouch to hold unattached and blank labels;
a changeable graphic display attached to the display board;
a calendar;
a hole to receive a fastener to secure to wall;
a stand to enable desktop display (as seen with picture frames).

12. The system according to claim 11, wherein the calendar is associated and attached to the system to attract daily engagement.

13. The system according to claim 11, further including a daily planner attached to the system to attract daily engagement.

14. The system according to claim 11, further including a daily vocabulary word dispenser attached to the system to attract daily engagement.

15. The system according to claim 11, further including a daily words of wisdom dispenser attached to the system to attract daily engagement.

16. The system according to claim 11, further including a shopping list holder attached to the system to attract daily engagement.

17. A good fortune counting and display system, including the following:
a display board;
a plurality of labels adapted to be attached to predetermined positions on the display board;
a plurality of magnets adapted to be placed under the labels;
a pouch to hold unattached and blank labels;
a changeable graphic display attached to the display board;
a calendar;
a plurality of sensors for detecting label, dial and slider positions;
a battery;
a controller;
a digital display;
a hole to receive a fastener to secure to wall;
a stand to enable desktop display (as seen with picture frames).

18. The system according to claim 11, wherein a plurality of sensors are adapted to be detect the position of the labels, dials and sliders.

19. The system according to claim 11, the controller receives data from the sensors and calculates a total good fortune score

20. The system according to claim 11, the digital display receives data from the controller and displays the good fortune score.
